(19) United States
(12) Patent Application Publication
(10) Pub. No.: US 2025/0232103 A1
(43) Pub. Date: Jul. 17, 2025

(54) POWER MODELED INTEGRATED CIRCUIT

(71) Applicant: INTERNATIONAL BUSINESS MACHINES CORPORATION, ARMONK, NY (US)

(72) Inventors: Spandana V. RACHAMALLA, BENGALURU (IN); Arun JOSEPH, Kadugodi (IN); Nagashyamala R. DHANWADA, Tenafly, NJ (US); Rahul M. Rao, BANGALORE (IN)

(21) Appl. No.: 18/532,238

(22) Filed: Jan. 17, 2024

(51) Int. Cl. G06F 30/343

(52) U.S. Cl. CPC G06F 30/343

(57) ABSTRACT

Methods, computer program products, and systems are presented. The method computer program products, and systems can include, for instance: performing logic simulation of a cell and determining, in dependence on the performing logic simulation of the cell, a first at least one component of power consumption of the cell, wherein the cell is included in a transistor level IC design selected for modeling; determining, with use of a sensitivity transfer function, a second at least one component of power consumption of the cell, wherein generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell.

### BACKGROUND

The present disclosure relates generally to the field of computer hardware, and more particularly to a powered modeled integrated circuit.

Power consumption of electrical components is often characterized as including dynamic power consumption and static (also referred to as leakage) power consumption. One component of power consumption is cross current power consumption, also referred to as crowbar or shoot-through power consumption, which occurs when there is a cross current. Cross current occurs when current flows directly from a positive power supply rail to a lower supply rail, such as a ground or negative power supply rail, without providing useful function, resulting in wasted power within the electrical component.

Data structures have been employed for improving operation of a computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: performing logic simulation of a cell and determining, in dependence on the performing logic simulation of the cell, a first at least one component of power consumption of the cell, wherein the cell is included in a transistor level IC design selected for modeling; determining, with use of a sensitivity transfer function, a second at least one component of power consumption of the cell, wherein generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell; wherein the transistor level IC design is provided for fabrication of an integrated circuit.

In another aspect, a computer program product can be provided. The computer program product can include a computer readable storage medium readable by one or more processing circuit and storing instructions for execution by one or more processor for performing a method. The method can include, for example: Performing logic simulation of a cell and determining, in dependence on the performing logic simulation of the cell, a first at least one component of power consumption of the cell, wherein the cell is included in a transistor level IC design selected for modeling; determining, with use of a sensitivity transfer function, a second at least one component of power consumption of the cell, wherein generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell; wherein the transistor level IC design is provided for fabrication of an integrated circuit.

In a further aspect, a system can be provided. The system can include, for example, a memory. In addition, the system can include one or more processor in communication with the memory. Further, the system can include program instructions executable by the one or more processor via the memory to perform a method. The method can include, for example: Performing logic simulation of a cell and determining, in dependence on the performing logic simulation of the cell, a first at least one component of power consumption of the cell, wherein the cell is included in a transistor level IC design selected for modeling; determining, with use of a sensitivity transfer function, a second at least one component of power consumption of the cell, wherein generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell; wherein the transistor level IC design is provided for fabrication of an integrated circuit.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a circuit modeling manager system (CMMS), user equipment (UE) devices, enterprise systems and data sources according to one embodiment;

FIG. 2A is a circuit diagram illustrating cross current according to one embodiment;

FIG. 2B is a diagram illustrating cross current according to one embodiment;

FIGS. 3A-3B is a flowchart illustrating a method for performance by a CMMS interoperating with a UE device according to one embodiment;

FIG. 4 is circuit diagram illustrating first and second cells according to one embodiment;

FIG. 5 is a clustering analysis diagram according to one embodiment;

FIG. 6 is a cross current power consumption transform diagram according to one embodiment;

FIG. 7 depicts modeling of an IC design according to one embodiment;

FIG. 8 depicts a computing environment according to one embodiment.

### DETAILED DESCRIPTION

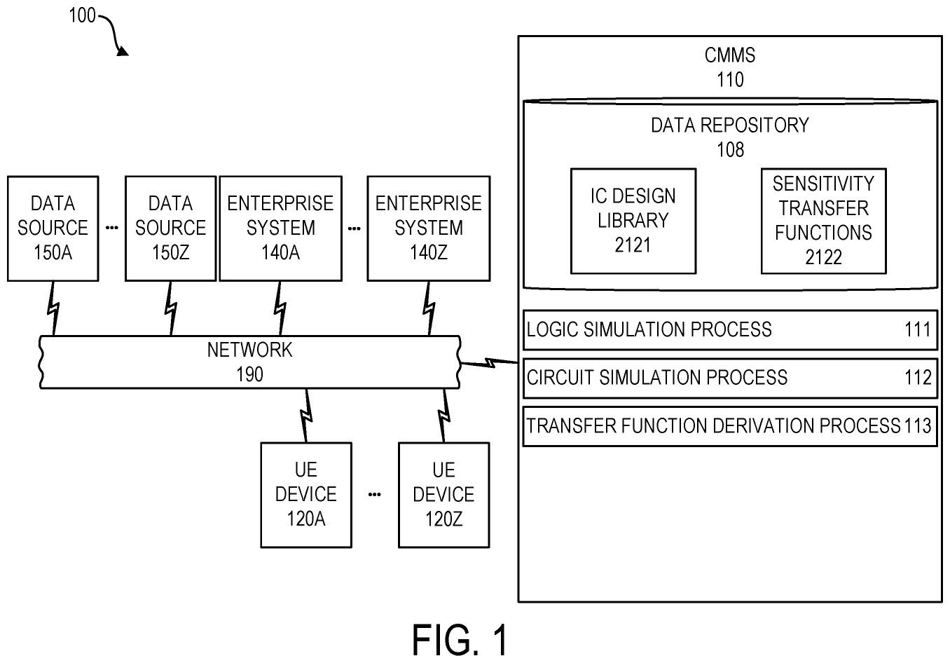

System 100 for use in performance of circuit modeling is shown in FIG. 1. System 100 can include circuit modeling manager system (CMMS) 110, having data repository 108, user interface equipment (UE) devices 120A-120Z, enterprise systems 140A-140Z, and data sources 150A-150Z. CMMS 110, UE devices 120A-120Z, enterprise systems 140A-140Z, and data sources 150A-150Z can be computing node based devices connected via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

In some embodiments, CMMS 110 can be external to each of UE devices 120A-120Z, enterprise systems 140A-140Z, and data sources 150A-150Z. In some embodiments, CMMS 110 can be co-located with instances of UE devices 120A-120Z, enterprise systems 140A-140Z, and data sources 150A-150Z.

UE devices 120A-120Z can be UE devices of administrator users of CMMS 110. UE devices 120A-120Z can include, e.g., laptops, personal computers, tablets, smartphones and the like. Enterprise systems 140A-140Z can be enterprise systems associated to different enterprises, such as enterprises benefiting from services provided by CMMS 110, and/or enterprises providing materials, fabrication equipment, instruments, capabilities, for use in providing integrated circuits subject to modeling by CMMS 110. Data sources 150A-150Z can include systems of trusted research entities, including standards providing entities. From time to time, CMMS 110 can update functions provided by processes run by CMMS 110 in dependence on data queried from enterprise systems 140A-140Z and/or data sources 150A-150Z.

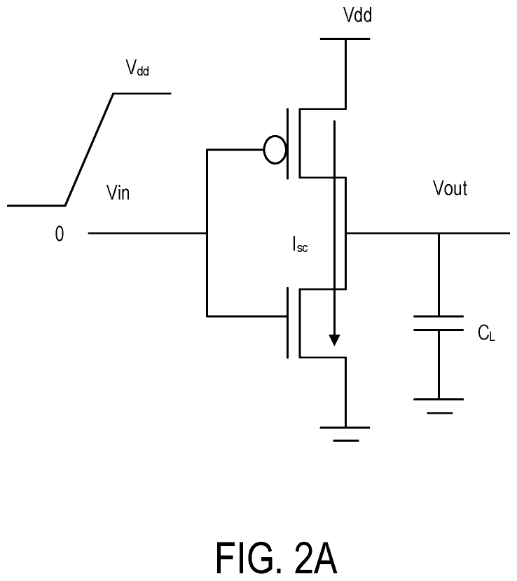

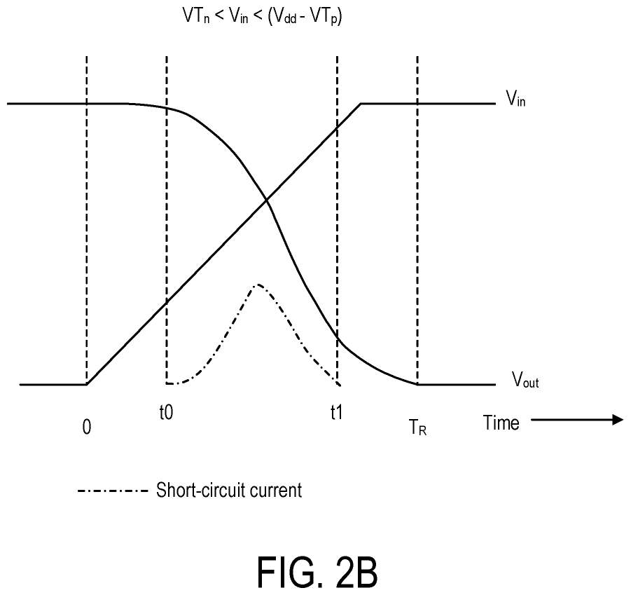

As set forth in reference to FIGS. 2A and 2B, embodiments herein recognize that cross current occurs when current flows directly from a positive power supply rail to a lower supply rail, such as a ground or negative power supply rail, without providing useful function, resulting in wasted power within the electrical component. FIG. 2A illustrates a scenario in which cross current power dissipation occurs in a simple inverter circuit. Cross current power occurs when both pull-up and pull-down networks are on at the same time. When the input (Vin) of the gate switches (e.g., 0 to V_{DD}), for a small amount of time there is a direct path from V_{DD} to V_{SS} when both the FETs are on and current (Isc) flows through. FIG. 2B illustrates waveforms of input (Vin) and output (Vout) of an inverter when the input changes from 0 to V_{DD}. Embodiments herein recognize that there is a small amount of time t0 to t1, when the Vin is greater than VTn (Threshold voltage of nFET) but less than V_{DD}−VTp (V_{DD}−threshold voltage of pFET). During this time, both the nFET and pFET are ‘on’ and cross current power dissipation occurs. Embodiments herein recognize that challenges exist with respect to modeling cross current. In one aspect, logic simulation alone is not able to model cross current power consumption due to its dependence on input slew. Embodiments herein also recognize that employing circuit simulation for modeling cross current can consume extensive computing resources.

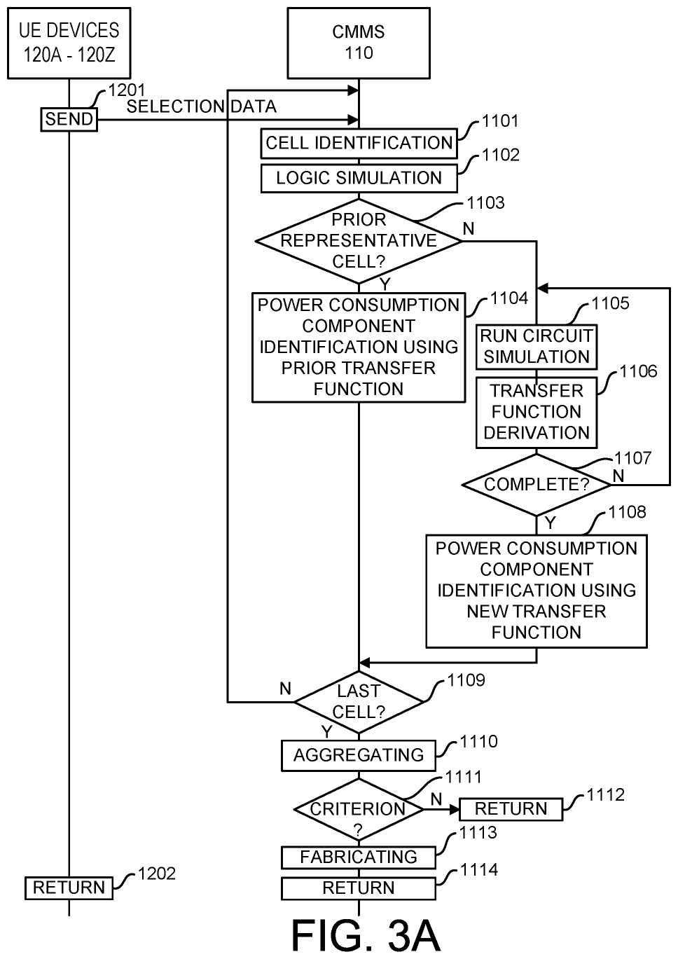

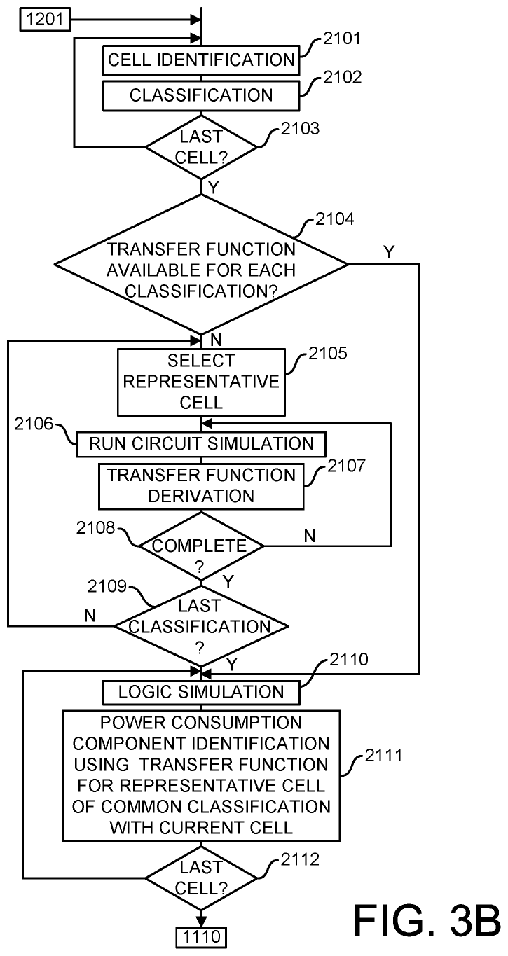

Data repository 108 in integrated circuit (IC) design library 2121 can store various IC designs. In some embodiments, IC designs in IC design library 2121 can include, e.g., cell level IC designs, sub chip level IC designs, and chip level IC designs. Cell level IC design herein can refer to an IC design for a specific function. A cell level IC design can be a design having one or more transistor arranged to perform a specific function. For example, an inverter cell can be a CMOS inverter that includes two transistors arranged as shown in FIGS. 3A-3B. Other cells can be considerably more complicated. For example, a cell may include one or more inverters, logic gates (such as the CMOS AND gate shown in FIGS. 3A-3B), amplifiers, flip flops, or other circuitry in any number of different configurations. A chip level design IC herein can refer to an IC design for an entire IC chip. A sub-chip level IC design herein can refer to a design for a portion of an IC chip. A sub chip IC design herein can include a combination of cell level IC designs.

In some embodiments, an IC design stored in IC design library 2121 can be in the form of a netlist. A netlist is a description of the connectivity of electrical components in a circuit. In its simplest form, a netlist contains a list of the terminals of all electronic components in a circuit and a list of the nets (e.g., electrical conductors) that interconnect the terminals. For example, a netlist may comprise compiled or otherwise processed data structures representing a list of wires, discrete components, logic gates, control circuits, I/O devices, models, etc. that describes the connections to other elements and circuits in an integrated circuit design (e.g., a design structure). The netlist can be synthesized using an iterative process in which the netlist is resynthesized one or more times depending on design specifications and parameters for the device. As with other design structures, the netlist can be recorded on a machine-readable data storage medium. The medium can be a non-volatile storage medium such as a magnetic or optical disk drive, a compact flash, or other flash memory. Additionally, or in the alternative, the medium can be a system or cache memory, buffer space, or electrically or optically conductive devices and materials on which data packets can be transmitted and intermediately stored via the Internet, or other networking suitable means. In IC design library 2121, there can be stored associated modeling results obtained pursuant to modeling of a respective IC design.

Data repository 108 in sensitivity transfer functions area 2122 can store sensitivity transfer functions. Embodiments herein recognize that challenges exist with respect to modeling cross current. In one aspect, logic simulation alone is not able to model cross current power consumption due to its dependence on input slew. Embodiments herein also recognize that employing circuit simulation for modeling cross current can consume extensive computing resources. Embodiments herein produce sensitivity transfer functions for representative cells. For generation of a sensitivity transfer function, CMMS 110 can perform circuit simulation on a representative cell and based on the results of the circuit simulation, CMMS 110 can produce a sensitivity transfer function. The sensitivity transfer function can model sensitivity of power consumption of a cell in terms of slew sensitivity and/or load sensitivity. For determining cross current power consumption for a certain cell, CMMS 110 can query a sensitivity transfer function associated to a representative cell having a classification in common with the certain cell. Sensitivity transfer functions area 2122 can define a library of previously generated sensitivity transfer functions, and methods herein can include maintaining a library of previously generated sensitivity transfer functions defined by sensitivity transfer function area 2122.

CMMS 110 can run various processes. CMMS 110 running logic simulation process 111 can include CMMS 110 performing a logic simulation. Logic simulation models circuits (e.g., IC designs) as a collection of transistors which are connected using wires. This transistor level connectivity information includes a list of transistors and wires, and provides information similar to the schematic of the same IC design. In logic simulation, transistors are treated as binary switches and wires are modeled as connectors. The network of transistors and wires are used to create a binary decision diagram, which is then used to compute statistics such as the toggle count for each internal node, using a particular activity pattern. The activity pattern can be the input applied to a cell during transistor level logic simulation. For example, an inverter may have an input A and an output Y. The activity pattern may define the pattern of inputs (e.g., 0 or 1) applied to the inverter input A. (e.g., 001101). The activity pattern may also define the rate at which the pattern transitions from one input to another (e.g., how long a first input value is applied before transitioning to the next input value).

The information derived from transistor level logic simulation is logged along with other information (such as device and wire capacitances derived from offline circuit simulation) to enable logic simulation based power modeling. Embodiments herein recognize that logic simulation generally is less accurate than traditional circuit simulation techniques, but can be considerably faster. An IC design that may take several days or weeks to model using circuit simulation techniques may only take a few hours using logic simulation techniques. Embodiments herein recognize that while most power components can be modeled using logic simulation, logic simulation alone is not able to model cross current power consumption due to its dependence on the input slew.

CMMS 110 performing circuit simulation process 112 can include CMMS 110 performing a circuit simulation for an IC design. CMMS 110 running circuit simulation process 112 can include CMMS 110 using mathematical models to replicate the behavior of electronic devices and/or circuits. Electronic circuit simulators can be either analog simulators or mixed-mode simulators, which are capable of both analog and event-driven digital simulation. In some embodiments, the cross current effective capacitance model for a distinctive cell can be generated by simulating the cross current power consumption of the distinctive cell using traditional circuit simulation techniques. The simulation may involve sweeping across a range of values for the various factors of cross current power consumption. For example, a user may want to generate a cross current effective capacitance model parameterized by the slew rate and positive supply voltage V_{DD}. The simulation may determine the cross current power consumption of the distinctive cell with different combinations of slew rate and positive supply voltage V_{DD}. The slew rate and positive supply voltage V_{DD} can be simulated within operating ranges consistent with their intended use.

CMMS 110 running transfer function determining process 113 can include CMMS 110 producing a sensitivity transfer function for a representative circuit. For performance of transfer function determining process 113, CMMS 110 can run circuit simulation process 112 to generate a set of output parameters. CMMS 110 can then process the output parameters to generate a sensitivity transfer function.

A method for performance by CMMS 110 interoperating with UE devices 120A-120Z is set forth in reference to FIGS. 3A-3B. At block 1201 a UE device of UE devices 120A-120Z can be sending selection data for receipt by CMMS 110. A UE device of UE devices 120A-120Z can be associated to an administrator user of CMMS 110, wherein the administrator user is responsible for establishing selection data for input into CMMS 110. The described selection data establishes attributes of the performance of operations performed by CMMS 110, when performing circuit modeling. The selection data sent at block 1201 can include selection data for selecting a certain IC design from IC design library 2121 for subjecting to circuit modeling.

On receipt of the selection data sent at block 1201, CMMS 110 can proceed to block 1101. At block 1101, CMMS 110 can perform cell identification for the input IC design input by the selection data sent at block 1201. In the described embodiment set forth in reference to the flowchart of FIGS. 3A-3B, the selected IC design can be a sub chip IC design. In another embodiment, the selected IC design can be a cell level IC design.

At block 1101, CMMS 110 can perform cell identification. CMMS 110 can employ various methodologies at block 1101 for performance of cell identification. In some embodiments, CMMS 110 may break the IC design into individual cells by identifying boundary nets that exist between, and separate, individual cells. The computer system may identify that a net is a boundary net if the net is driven by a drain of one or more FETs and simultaneously drives either one or more FETs' gates or the primary output(s) (PO) of a cell. Additionally, nets that are driven by the drain of one or more FETs can be boundary nets if the FETs' gates are driven by the primary input(s) (PI) of the same cell. The groups of transistors between boundary nets can be considered individual cells. CMMS 110 can be programmed to recognize certain IC designs, such as common IC designs, and identify the cells within them.

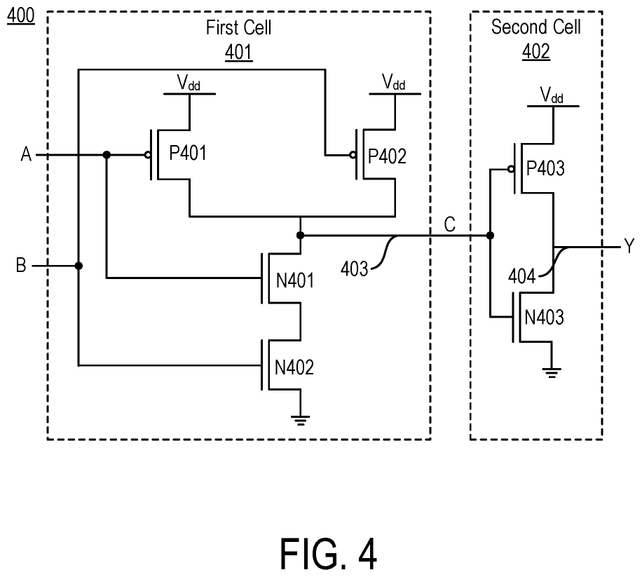

In reference to FIG. 4, there is shown is an exemplary IC design 400 that can be modeled, in accordance with embodiments of the present disclosure. In the example of FIG. 4, IC design is provided by a two cell design; however, it is understood that an IC design subject to modeling herein can comprise any number of cells. The IC design 400 can be a CMOS AND gate having a first cell 401 and a second cell 402. The first cell 401 can be in a stacked base configuration, while the second cell 402 can be in an inverter base configuration. The IC design 400 of the CMOS AND gate may correspond to a cell in a transistor level design library. The first cell 401 is a CMOS NAND gate and the second cell 402 is a CMOS inverter. The first cell 401 and second cell 402 are connected by a net 403 (e.g., a conductive wire or track). The net 403 can be regarded as a boundary net because it connects two cells together.

The first cell 401 may include two pFETs P401 and P402, as well as two nFETs N401 and N402. The pFETs P401 and P402 can be connected by their sources to a positive supply voltage V_{DD}, and by their gates to inputs A and B, respectively. The drains of the pFETs P401 and P402 can be connected to each other, to the drain of the first nFET N401, and to the net 403. The source of the first nFET N401 can be connected to the drain of the second nFET N402, and the gate of the first nFET N401 can be connected to the first input A. The gate of the second nFET N402 can be connected to the second input B, and the source of the second nFET N402 can be connected to ground (or, alternatively, to a negative supply voltage V_{SS}). The drains of the first and second pFETs P401, P402 and the first nFET N401 may connect the first cell 401 to the second cell 402 via the net 403. Inputs A and B can be primary inputs for the CMOS AND gate, as well as for the first cell 401.

The second cell 402 may include a third pFET P403 and a third nFET N403. The source of the third pFET P403 can be connected to the positive supply voltage V_{DD}. The gate of the third pFET P403 can be connected to the output C of the NAND gate (first cell 401), which also acts as an input for the second cell 402. The drain of the third pFET P403 can be connected to the output Y of the AND gate and to the drain of the third nFET N403. The gate of the third nFET N403 can be connected to the output C of the NAND gate (first cell 401), and the source of the third nFET N403 can be connected to ground (or, alternatively, to a negative supply voltage V_{SS}). Output Y can be a primary output for the CMOS AND gate and for the second cell 402.

There are several ways that the computer system may identify that the IC design 400 of the CMOS AND gate has two cells. First, the computer system can be programmed to recognize certain IC designs, such as common IC designs, and identify the cells within them. Because a CMOS AND gate is a relatively common component, the computer system can be programmed to recognize the IC design 400 of the CMOS AND gate as being a two-cell design.

Alternatively, the computer system may recognize the two cells of the IC design 400 by identifying that net 403 is a boundary net that separates two groups of transistors (e.g., cells). The net 403 is connected to, and driven by, the drains of the first pFET P401, the second pFET P402, and the first nFET N401. Additionally, the other end of the net 403 is connected to, and drives, the gates of the third pFET P403 and the third nFET N403. As discussed in reference to FIG. 1, the computer system may identify the net 403 as a boundary net because it is driven by the drains of one or more FETs (pFETs P401 and P402 and nFET N401) and also drives the gates of one or more other FETs (pFET P403 and nFET N403). Likewise, net 404, which carries the output signal Y, is a boundary net because it is driven by the drains of FETs whose sources are driven by a primary input. Specifically, both the third pFET P403 and the third nFET N403 are driven by a primary input (namely, signal C), and their drains drive the net 404. Because boundary nets separate individual cells, the computer system may recognize that the IC design 400 has two cells (namely, the first cell 401 and the second cell 402).

On completion of block 1101, CMMS 110 can proceed to block 1102. At block 1102, CMMS 110 can perform logic simulation for identified cell identified at the prior iteration of block 1101. CMMS 110 performing logic simulation at block 1102 can include CMMS 110 performing logic simulation for determination of components of power consumption of the cell identified at the preceding block 1101.

On completion of logic simulation block 1102, CMMS 110 can proceed to block 1103. Logic simulation models circuits (e.g., IC designs) as a collection of transistors which are connected using wires. This transistor level connectivity information includes a list of transistors and wires, and provides information similar to the schematic of the same IC design. In logic simulation, transistors are treated as binary switches and wires are modeled as connectors. The network of transistors and wires are used to create a binary decision diagram, which is then used to compute statistics such as the toggle count for each internal node, using a particular activity pattern. The activity pattern can be the input applied to a cell during transistor level logic simulation. For example, an inverter may have an input A and an output Y. The activity pattern may define the pattern of inputs (e.g., 0 or 1) applied to the inverter input A. (e.g., 001101). The activity pattern may also define the rate at which the pattern transitions from one input to another (e.g., how long a first input value is applied before transitioning to the next input value). The determined one or more component of power consumption determined by logic simulation can include slew independent switching power consumption and/or static power consumption.

At logic simulation block 1102, CMMS 110 can employ logic simulation for determination of slew independent switching power consumption and static power consumption. In employing logic simulation for determination of slew independent switching power consumption of a cell, CMMS 110 can perform node switching and recording of switching capacitance under varying cell circuit conditions. Performing node switching and recording of switching capacitance under varying cell circuit conditions models slew independent switching power consumption of a cell. In employing logic simulation for determination of static power consumption of a cell, CMMS 110 can perform node switching and recording of leakage duty cycle for respective FETs of the cell under varying cell circuit conditions. Performing node switching and recording of leakage duty cycle for respective FETs of the cell under varying cell circuit conditions models static power consumption of a cell.

At block 1103, CMMS 110 can determine whether there is a prior stored sensitivity transfer function within sensitivity transfer functions area 2123 of data repository 108 for a prior registered representative cell having a cell classification in common with the current cell identified at the most recent iteration of cell identification block 1101. At block 1103, CMMS 110 can perform clustering analysis for ascertaining whether there is a sensitivity transfer function stored within sensitivity transfer functions area 2122 associated to a representative cell of common family classification with the current cell identified and detected at the most recent iteration of block 1101.

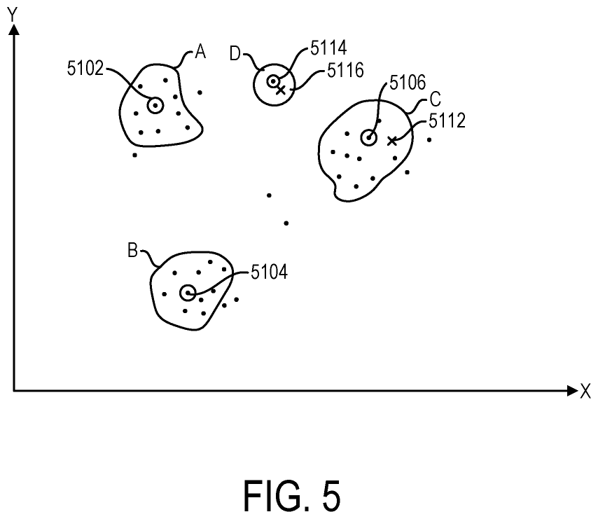

Such clustering analysis is described further in reference to FIG. 5. With reference to the clustering analysis diagram of FIG. 5, CMMS 110 can plot dimensional parameters of new incoming identified cells as they are identified. With reference to the clustering analysis diagram of FIG. 5 identified cells can be represented as dimensional vectors wherein the dimensional vectors can include first and second dimensional parameters that characterize the identified cell.

Dimensional parameters that can characterize a cell can include such parameters as, e.g., numbers of transistors, transistor base configurations (e.g., stacked base or inverter base), transistor type (e.g., bipolar-junction transistor (BJTs), field-effect transistor (FET), or metal-oxide-semiconductor field-effect transistors (MOSFET)), threshold voltages, and the like. In the example of FIG. 5, a simplified two dimensional parameter clustering analysis is depicted. However, it will be understood that clustering analysis can be scaled to encompass J dimensions.

In the clustering analysis diagram of FIG. 5, data points 5102, 5104, 5106 represented with a circle represent cells for which CMMS 110 has previously generated a sensitivity transfer function stored within since it is the transfer function area 2122 and the data point 5112 represented with an “X” can represent the current cell most recently identified at the most recent iteration of block 1101. Prior cells represented within the clustering analysis diagram of FIG. 5 can include cells of the current IC design identified with selection data sent at block 1201 and/or can include cells from prior historical IC design subject to modeling by CMMS 110 (prior to the selection data being sent at block 1201) for initiation of the current IC design circuit modeling.

At block 1103, CMMS 110 can ascertain whether the current cell identified at the most recent iteration of block 1101 is a cell of common family classification with a prior representative cell having an associated sensitivity transfer function stored in sensitivity transfer function area 2122. For such ascertaining, CMMS 110 can determine that the current cell is within a common cluster classification with the prior representative cell. In the described example of FIG. 5, CMMS 110, for example, can determine that both the current cell represented by data point 5112 is within the common cluster classification “C” of the depicted clusters, and can identify the prior representative cell represented by data point 5106 within cluster “C” as the prior representative cell for which there is a prior generated sensitivity transfer function stored within sensitivity transfer function area 2122.

In another example, CMMS 110 at determination block 1103 can determine that a current cell identified at the most recent iteration of block 1101 is commonly classified with a prior representative cell having an associated previously generated sensitivity transfer function based on a Euclidean distance between the current cell and the prior representative cell satisfying a Euclidean distance threshold indicative of the two cells being similar and commonly classified. In one example with reference to FIG. 5, CMMS 110 can determine that data point 5112 for the current cell is within a threshold Euclidian distance of data point 5106 for a prior representative cell having an associated previously generated sensitivity transfer functions, and thus can determine that the current cell represented by data point 5112 and the prior representative cell represented by data point 5106 are commonly classified.

On the determination at block 1103 that there is prior representative cell having an associated previously generated sensitivity transfer function associated to the current cell, CMMS 110 can proceed to block 1104. At block 1104, CMMS 110 can perform power consumption component identification using the prior generated transfer function.

An example of a generated sensitivity transfer function as set forth in reference to Eqs. 1-3 as set forth in greater detail subsequently herein, CMMS 110 can use a transfer function having characteristics depicted in Eqs. 1-3 for computing resource economized of cross current power consumption of the cell identified at block 1101.

CMMS 110 on determining at block 1103 that there is no prior representative cell having associated generated sensitivity transfer function in common with the current cell, CMMS 110 can proceed to block 1105. At block 1105, CMMS 110 can initiate generating a new sensitivity transfer function for computing resource economized determination of cross current power consumption.

At block 1105, CMMS 110 can run a circuit simulation on the currently identified cell identified at the most recent iteration of block 1101 and then at block 1106 can perform transfer function derivation to generate a transfer function to generate a sensitivity transfer function having characteristics described in reference to Eqs. 1-3, and then CMMS 110 can proceed to block 1107 to determine whether the transfer function derivation process has been completed. On the determination at block 1107 by CMMS 110 that the transfer function derivation process has not been completed, CMMS 110 can return to a stage prior to block 1105 and can iteratively perform the loop of blocks 1105-1107 until a time that derivation of a sensitivity transfer function has been completed. When CMMS 110 determines at block 1107 that the generation of a sensitivity transfer function has been complete, CMMS 110 can proceed to block 1108.

CMMS 110 at blocks 1105 and 1106 can measure power consumption of the selected representative circuit across a range of input slew values keeping other inputs (voltage, frequency, input patterns, load, etc.) constant. CMMS 110 performing the described circuit simulation can determine that any change in power consumption has resulted from the variation in input slew varied according to the circuit simulation and can empirically derive a slew sensitivity transfer function based on the returned output power consumption returned with input slew varied.

CMMS 110 at blocks 1105 and 1106 can measure power consumption of the selected representative circuit across a range of output loads keeping other inputs (voltage, frequency, input patterns, slew, etc.) constant. CMMS 110 performing the described circuit simulation can determine that any change in power consumption has resulted from the variation in the output load varied by the circuit simulation and can empirically derive a load sensitivity transfer function based on the returned output power consumption returned with output load varied.

CMMS 110 at block 1107 can output a sensitivity transfer function as set forth in reference to Eqs. 1-3, wherein Slew>Nominal Slew.

$$Xcurrent @ slew , load = Nominal Xcurrent + Xcurrent Slew Transform - Xcurrent Load Transform \qquad ( Eq . 1 )$$

$$Xcurrent @ slew , load = Nominal Xcurrent + \qquad ( Eq . 2 )$$

$$func ( Cell drive strength , slew , slew {sensitivity}_{ct} ) -$$

$$func ( load , load {sensitivity}_{ct} )$$

$$Xcurrent @ slew , load = Nominal Xcurrent + \qquad ( Eq . 3 )$$

$$Drive Strength * X 1 M Mslew * ( slew - nominal slew ) -$$

$$( K1slew\_load * slew * slew + {K2slew\_load}_{ct} * slew + {Kslew\_load}_{ct} ) * load$$

Referring to Eqs. 1-3, Slew>Nominal Slew, and Eqs. 1 and 2 can resolve to Eq. 3. Referring to Eq. 2 and Eq. 3, slew sensitivity_{ct}, load sensitivity_{ct}, K2slew_load_{ct}, Kslew_load_{ct} refer to factors that vary from representative cell to representative cell (CT). CMMS 110 at block 1107 can utilize the sensitivity transfer function of Eqs. 1-3 for computing resource economized determination of a cell's cross current power consumption including slew dependent cross current power consumption and/or load dependent cross current power consumption.

When CMMS 110 determines at block 1107 that circuit simulation and sensitivity transfer function derivation is complete, CMMS 110 can proceed to block 1108. At block 1108, CMMS 110 can perform computing resource economized determination of cross current power consumption of the current cell identified in the most recent iteration of block 1101 using the newly generated sensitivity transfer function generated at the prior iteration of blocks 1105-1107. In one example with reference to the clustering analysis diagram of FIG. 5, CMMS 110 can determine that there is no prior representative cell having an associated prior generated sensitivity transfer function for the new cell represented as data point 5114 and can register the new cell as a representative cell and can generate a new sensitivity transfer function for the new cell represented as data point 5114.

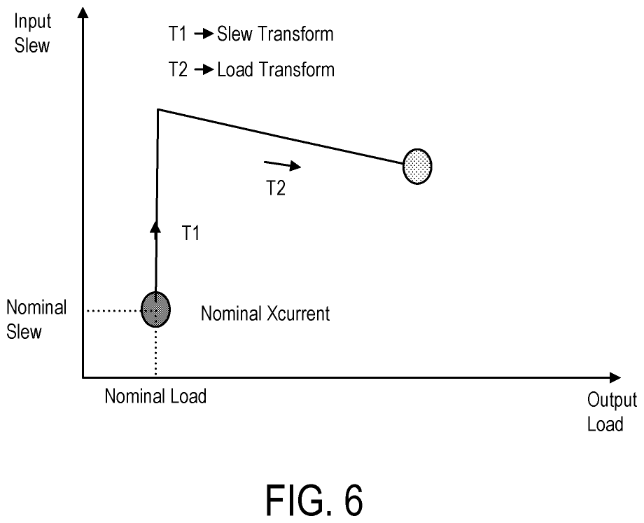

At block 1108, CMMS 110 can employ the transfer function of Eqs. 1-3 for computing resource economized determination of cross current power consumption. Given a nominal cross current power consumption and capacitance (at certain slew, load conditions) specified in the transfer function of Eqs. 1-3, CMMS 110 can determine cross current power consumption and capacitance for any desired slew and load condition with use of the transfer function of Eqs. 1-3 and a cross current power transform that transforms determined cross current power consumption at a nominal slew and load condition, to a determined cross current power at a new slew and load condition applicable for a current cell being modeled. In one embodiment, CMMS 110 can use the cross current power consumption transform of the transform diagram of FIG. 6 for transforming a determined cross current power consumption at a nominal slew and load condition, to a determined cross current power at a new slew and load condition applicable for a current cell being modeled.

At block 1104 previously referenced, CMMS 110 can employ the transfer function of Eqs. 1-3 for computing resource economized determination of cross current power consumption. Given a nominal cross current power consumption and capacitance (at certain slew, load conditions) specified in the transfer function of Eqs. 1-3, CMMS 110 can determine cross current power consumption and capacitance for any desired slew and load condition with use of the transfer function of Eqs. 1-3 and a cross current power transform that transforms determined cross current power consumption at a nominal slew and load condition, to a determined cross current power at a new slew and load condition applicable for a current cell being modeled. In one embodiment, CMMS 110 can use the cross current power consumption transform of the transform diagram of FIG. 6 for transforming a determined cross current power consumption at a nominal slew and load condition, to a determined cross current power at a new slew and load condition applicable for a current cell being modeled.

Embodiments herein recognize that because the transfer function facilitates determination of cross current power consumption at any desired slew and load, there is no need for circuit simulations at these conditions. Accordingly, computing resource consuming circuit simulations can be avoided. Nominal cross current power consumption and capacitance can be determined at nominal (certain slew, load) conditions. In one embodiment, nominal cross current power consumption and capacitance can be the minimal cross current power consumption and capacitance used, or the default cross current power consumption and capacitance can be the minimal cross current power consumption and capacitance used in the absence of information on slew and/or load.

In reference to Eqs. 1-3, the relationship between slew and power can be determined empirically as a function of drive strength on observation of power consumption across different cells within a common family type. Embodiments herein recognize that drive strength is a measure of a cell's load driving capacity which is directly related to its size.

Embodiments herein provide use of sensitivity transfer function which can be provided on a one-per-cell family classification basis. Accordingly, embodiments herein can provide accuracy benefits (including cross current modeling) associated with circuit simulations while performing circuit simulations on a limited number of cells defining a subset of cells of an IC design selected for modeling, e.g., representative cells that are representative of cells within a family classification of cells. Embodiments herein can use sensitivity transfer function based analysis which can employ circuit simulation on only subset of cells. The described processing provides efficiencies given that the number of simulations are limited—one cell per cell type—as opposed to all cells of an IC design.

When CMMS 110 during a subsequent iteration of block 1102 for modeling a current IC design can ascertain that the new cell represented as data point 5116 is commonly classified with the prior representative cell represented as data point (e.g., by satisfaction of a Euclidian distance threshold and/or determination that cells are commonly classified within cluster “D”), and for computing resource economized determination of cross current power consumption can use the previously generated sensitivity transfer function for the representative cell represented by data point 5114.

On completion of block 1104 or block 1108, i.e., depending on which path is taken, CMMS 110 can proceed to block 1109. At block 1109, CMMS 110 can ascertain whether the current cell identified at the most recent iteration of block 1101 is the last cell within an IC design identified with selection data sent at block 1101. On the determination that the current cell identified at the most recent iteration of block 1101 is not the last cell of the current IC design identified with selection data sent at block 1201, CMMS 110 can return to a stage prior to block 1101 to identify a next cell within an IC design using the cell identification methodology set forth previously herein. CMMS 110 can proceed iterations of the loop of blocks 1101-1109 (using the path of block 1104, or the alternative path of blocks 1105-1108) until at block 1109, CMMS 110 ascertains that the current cell which is the cell identified within the most recent iteration of block 1101 is the last cell within an IC design identified with selection data sent at block 1101.

On the determination at block 1109 that the current cell is the last cell of an overall IC design subject to modeling with selection data sent at block 1101, CMMS 110 can proceed to aggregating block 1110. At aggregating block 1110, CMMS 110 can perform aggregating of power consumption parameter values produced at prior processing blocks.

In one embodiment, processing at blocks 1101 to 1109 of FIG. 3A can be replaced by the alternative processing described with reference to blocks 2101 to 2112 as set forth in FIG. 3B.

Referring to FIG. 3B, CMMS 110 can initially identify each cell within a received IC design specified by selection data sent at block 1201 and then can determine whether any cell within the IC design is absent of an associated sensitivity transfer function. On determination that there is no sensitivity transfer function associated to a given cell, CMMS 110 can identify a representative cell for the given family classification and derive a sensitivity transfer function for the representative cell. CMMS 110 can continue the process until there is stored within sensitivity transfer functions area 2122 sensitivity transfer function for each possible family classification within an IC design. In selecting a representative cell that is representative of a family classification of cells, CMMS 110 can identify the smallest cell within the family classification regarding the process. Embodiments herein recognize that selecting a cell in dependence on size, e.g., selecting a cell that is the smallest amongst its family allows for faster circuit simulation. Embodiments herein recognize that sensitivity transfer functions herein selectively generated for a limited number of representative cells can remove the need for complete library circuit simulations (which is computing resource and time consuming) while still maintaining accuracy.

Referring now to specific processing set forth in FIG. 3B, CMMS 110 at block 2101 can perform cell identification in the manner described with reference to block 1101 and can proceed to block 1102. At block 2102, CMMS 110 can classify the cell using the clustering technique described in reference to FIG. 5. At block 2102, CMMS 110 can record dimensional attributes of a data point representing each incoming identified cell into clustering plot, and can determine family classifications based on clustering analysis described in reference to FIG. 5.

On completion of block 2102, CMMS 110 can proceed to block 2103. At block 2103, CMMS 110 can determine whether CMMS 110 has identified the last cell within an IC design. CMMS 110 can iteratively perform the loop of blocks 2101 to 2103 until the last cell is identified and classified as bellowing to a cell classification family within an IC design. When CMMS 110 determines that a last cell within an IC design has been identified and classified, CMMS 110 can proceed to block 2104.

At block 2104, CMMS 110 can ascertain whether a sensitivity transfer function is available and previously stored within sensitivity transfer functions area 2122 of data repository 108 for each classification associated to each cell identified at block 2101. On determination that one or more cell is absent an associated sensitivity transfer function, CMMS 110 can proceed to block 2105. CMMS 110 can determine that a certain cell is absent of an associated sensitivity transfer function when CMMS 110 determines that no representative cell of common family classification with the certain cell that includes as associated sensitivity transfer function stored in sensitivity transfer function area 2122.

At block 2105, CMMS 110 can select a representative cell for a family classification of the current IC design that is missing a representative cell having an associated transfer function. On selection of a representative cell, CMMS can register the cell in IC design library 2121 as a registered representative cell and can generate and derive a registered sensitivity transfer function for the representative cell for storage into sensitivity transfer function area 2122. At block 2105, CMMS 110 can identify the representative cell in dependence on cell size, e.g., in dependence on which cell is the smallest within a family classification identified at block 2104 as being absent a sensitivity transfer function. In one embodiment, CMMS 110 can determine cell size at block 2105 in dependence on average number of fins per transistor of the cell. In one embodiment, CMMS 110 can determine cell size at block 2105 in dependence on average size dimensions of transistors of the cell. In one embodiment, CMMS 110 can select the cell with the smallest size, driving the smallest load as the representative cell of a cell family classification for slew and load sensitivity analysis. In selecting the representative cell based on size of the cell, CMMS 110 reduces computing resource consumption (including computing time) associated to circuit simulation for sensitivity transfer function derivation.

Accordingly, there is set forth herein, according to one embodiment, performing logic simulation of a cell and determining, in dependence on the performing logic simulation of the cell, a first at least one component of power consumption of the cell, wherein the cell is included in a transistor level IC design selected for modeling; determining, with use of a sensitivity transfer function, a second at least one component of power consumption of the cell, wherein generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell; wherein the transistor level IC design is provided for fabrication of an integrated circuit, wherein the representative cell that has been subject to circuit simulation has been selected from a set of candidate cells, wherein selecting the representative cell from the set of candidate cells has included evaluating transistor dimensions of the set of candidate cells. In the described embodiment, the set of candidate cells can include the cells of the IC design selected for modeling with the selection data sent at 1201.

On completion of block 2105, CMMS 110 can proceed to block 2106. At block 2106, CMMS can initiate circuit simulation for sensitivity transfer function derivation and at block 2107 can perform transfer function derivation. At block 2108, CMMS 110 can ascertain whether transfer function derivation has been completed for the current representative cell and CMMS 110 can iteratively perform the loop of blocks 2106-2108 for a time that transfer function derivation is being completed. When CMMS 110 determines at block 2108 that sensitivity transfer function derivation has been completed for a current representative cell, CMMS 110 can proceed to block 2109. At blocks 2106-2108, CMMS 110 can perform sensitivity transfer function derivation in the manner described with reference to 1105-1107.

At block 1109, CMMS 110 can ascertain whether CMMS 110 has derived transfer function for the last identified classification within a current IC design identified as missing a sensitivity transfer function at block 2109. On the determination that there are additional classifications for which a transfer function is to be derived, CMMS 110 can return to proceeding block 2105 and can iteratively perform the loop of blocks 2105-2109 until a sensitivity transfer function has been derived for all classifications of a current IC design selected for modeling with selection data sent at block 1201. On the determination that a sensitivity transfer function has been derived for all classifications of a current IC design, CMMS 110 can proceed to block 2110.

At block 2110, CMMS 110 can perform logic simulation for a current, e.g., first identified cell identified at block 2101 as recorded on a list at block 2101. CMMS 110 can perform logic simulation at block 2110 in the manner described with reference to block 1102.

On completion of block 2110, CMMS 110 can proceed to block 2111. At block 2111, CMMS 110 can determine cross current power consumption of the current cell using a sensitivity transfer function stored in sensitivity transfer functions area 2122 associated to a representative cell of common classification with the current cell. On completion of block 2109, there will be available within sensitivity transfer functions area 2122 sensitivity transfer function for each family classification of cells within a current IC design. Accordingly, at block 2111, CMMS 110 can select a prior stored sensitivity transfer function associated to a representative cell of common family classification with a current cell.

CMMS 110 determining cross current power consumption using a sensitivity transfer function can be performed in the manner described with reference to block 1104 and block 1108. CMMS 110 can perform power consumption component identification using the transfer function for the representative cell having a common classification with the current cell stored within sensitivity transfer functions area 2122.

Where CMMS 110 determines at block 2104 that there is a prior stored sensitivity transfer function available for each identified cell family classification of a current IC design, CMMS 110 can bypass blocks 2105-2109 and can jump to logic simulation block 2110.

On completion of block 2111, CMMS 110 can proceed to block 2112. At block 2112, CMMS 110 can ascertain whether the current cell is the last cell of the current IC design and can iteratively perform the loop of blocks 2110-2112 until a time that CMMS has determined that blocks 2110 and 2111 have been completed for a last cell within a current IC design. When CMMS 110 determines that blocks 2110 and 2111 have been completed for each cell of the current IC design, CMMS 110 can proceed to aggregating block 1110 as shown in FIG. 3A. Aggregating at aggregating block 1110 can be performed in the manner set forth in reference to Eqs. 4 and 5 herein.

At aggregating block 1110, CMMS 110 can aggregate determined power consumption components for each respective prior identified cell with use of Eq. 4.

$${P}_{CELL} = {P}_{LOGIC} + {P}_{STF} = {P}_{SIS} + {P}_{STATIC} + {P}_{CC} \qquad ( Eq . 4 )$$

Where P_{CELL} is the aggregated cumulative determined power consumption for a cell, where P_{LOGIC} is the one or more component of power consumption for an identified cell determined using logic simulation, and wherein P_{STF} is the one or more component of power consumption for a cell determined using a generated sensitivity transfer function having characteristics set forth in reference to Eqs. 1-3.

In one embodiment, CMMS 110 for a respective cell can employ logic simulation at block 1101 for determination of slew independent switching power consumption (P_{SIS}) and static power consumption (P_{STATIC}), and at block 1104 or block 1108 can employ a sensitivity transfer function as set forth in reference to Eqs. 1-3 for computing resource economized determination of cross current power consumption (P_{CC}).

CMMS 110 can employ Eq. 4 for determination of power consumption at a given cell of an IC design. For example, for a respective cell identified at identifying block 1101, CMMS 110 can aggregate one or more component of cell power consumption determined using logic simulation at block 1102 with a cross current power consumption component determined using a sensitivity transfer function as explained with reference Eqs. 1-3 for the given cell.

At aggregating block 1110, CMMS 110 can further aggregate determined power consumption for the various given cells. CMMS 110, for example, at block 1110 can determine an overall power consumption of an IC design subject to modeling by aggregating determined power consumption for each identified cell within the IC design. For determining an overall power consumption of an IC design designated for modeling with selection data sent at block 1201, CMMS 110 at aggregating block 1110 can employ Eq. 5 as follows.

$${P}_{DESIGN} = {\sum }_{i = 1}^{M} {P}_{CELL ( i )} \qquad ( Eq . 5 )$$

Where P_{DESIGN} is the overall modeled and determined power consumption for an IC design subject to modeling as specified in the selection data sent at block 1201, P_{CELL} is the determined power consumption for a respective cell as determined using Eq. 4, where i is the cell number, and where M is the number of cells in the IC design selected for modeling. As set forth herein, logic simulation can be used to compute slew independent switching power consumption and static power consumption for a cell. For certain conditions, logic simulation can be performed that features node switching. Node switching can be employed to compute switching capacitance which can be used to model slew-independent switching component. Similar logic simulation can be performed to compute leakage duty cycle on respective FETs of a cell to model the static power. In a further aspect slew-dependent cross current power consumption and capacitance can be determined using the sensitivity transfer function set forth in reference to Eqs. 1-3. As shown in Eq. 5, the summation of all the cells will give the total power of a selected IC design selected for modeling.

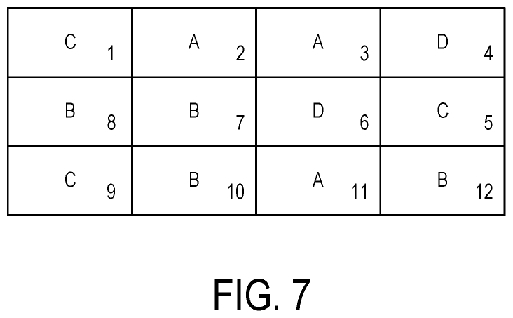

CMMS 110 performing processing in accordance with the flowchart of FIGS. 3A-3B, for illustrative IC design is described in reference to FIG. 7. In FIG. 7, an IC design selected for modeling with selection data sent at block 1201 can include 12 cells, which are labeled cells cell1-cell12 in the example of FIG. 7. In one example, CMMS 110 can identify the cells cell1-cell12 according to the ordering listed in FIG. 7. That is, CMMS 110 can first identify cell1, then cell2 and so on. As CMMS 110 identifies cells, CMMS 110 can ascertain whether the currently identified cell is commonly classified with a prior stored representative cell having an IC design stored in IC design library 2121 and having an associated prior generated transfer function stored in sensitivity transfer function area 2122.

In some scenarios, CMMS 110 can determine that an identified cell has a common family classification with a prior registered cell that has an associated previously generated sensitivity transfer function previously generated prior to initiating modeling of the current IC design currently selected for IC modeling with the most recent sending of selection data sent at block 1201. In other scenarios, CMMS 110 can ascertain that a current cell has a common family classification with an historical cell having an associated previously generated sensitivity transfer functions, where the previously generated transfer function was previously generated subsequent to initiation of modeling of the current IC design, i.e., after the sending of selection data sent at block 1101. In other scenarios, as explained with reference to data points 5114 and 5116 of FIG. 5, responsively to the identification of cells cell1-cell12 in the scenario described in reference to FIG. 7, CMMS 110 can determine that there is no prior cell in IC design library 2121 having an associated prior generated sensitivity transfer function, in which case CMMS 110 can generate a new sensitivity transfer function by processes set forth herein and can use the newly generated sensitivity transfer function for identification of a power consumption component for the current cell, and potentially additional subsequently identified cells within a current IC design subject to modeling to the extent the subsequently identified cells have a common family classification with a registered representative cell associated to the newly generated transfer function.

With reference to the example shown in FIG. 7, CMMS 110 in performing processing set forth in reference to the flowchart of FIG. 4 can determine that cells cell1, cell5, and cell9 have the cell cluster family classification of “C” that cells cell2, cell3, and cell1l have the common cell cluster family classification of “A”, that cells cell7, cell8, cell10, and cell12 have the common cluster classification of “C”, and that cells cell4 and cell6 have the common cluster classification of “D”. CMMS 110 can employ logic simulation on the respective cells for determination of slew independent switching power consumption and static power consumption. For determination of cross current power of the respective cells, CMMS 110 can select and use a previously generated sensitivity transfer function generated for a representative cell. For such functioning, CMMS 110 can maintain a library of previously generated sensitivity transfer functions stored in sensitivity transfer functions area 2122. Further, CMMS 110 can select the sensitivity transfer function for use in determining cross current power consumption for a respective cell from the library of previously generated sensitivity transfer functions responsively to ascertaining, with use of clustering analysis, that the respective cell is of a common family classification with the representative cell. For use in determining cross current power consumption of a certain cell within cluster family classification “A”, CMMS 110 can select a certain sensitivity transfer function from sensitivity transfer functions area 2122 responsively to determining that the current cell is of a common family classification with a certain representative cell within the cluster family classification “A” associated to the certain sensitivity transfer function. For use in determining cross current power consumption of a certain cell within cluster family classification “B”, CMMS 110 can select a certain sensitivity transfer function from sensitivity transfer functions area 2122 responsively to determining that the current cell is of a common family classification with a certain representative cell within the cluster family classification “B” associated to the certain sensitivity transfer function. For use in determining cross current power consumption of a certain cell within cluster family classification “C”, CMMS 110 can select a certain sensitivity transfer function from sensitivity transfer functions area 2122 responsively to determining that the current cell is of a common family classification with a certain representative cell within the cluster family classification “C” associated to the certain sensitivity transfer function. For use in determining cross current power consumption of a certain cell within cluster family classification “D”, CMMS 110 can select a certain sensitivity transfer function from sensitivity transfer functions area 2122 responsively to determining that the current cell is of a common family classification with a certain representative cell within the cluster family classification “D” associated to the certain sensitivity transfer function. While the illustrative example of FIG. 7 is set forth in reference to a limited number of cells, embodiments herein recognize that in practice IC designs can include a fewer number of cells and cell classifications, or alternatively, a larger number of cells and cell cluster classification, e.g., thousands to millions or billions of cells and cell cluster classifications.

Accordingly, there is set forth herein, according to one embodiment, performing logic simulation of a cell and determining, in dependence on the performing logic simulation of the cell, a first at least one component of power consumption of the cell, wherein the cell is included in a transistor level IC design selected for modeling; determining, with use of a sensitivity transfer function, a second at least one component of power consumption of the cell, wherein generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell; wherein the transistor level IC design is provided for fabrication of an integrated circuit, wherein the method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, wherein generating of the second sensitivity transfer function has included subjecting a second representative cell to circuit simulation, the second representative cell having a common family classification with the cell; and ascertaining a power consumption of the second cell in dependence on the first at least one component of power consumption of the second cell and in dependence on the second at least one component of power consumption of the second cell; and finding a power consumption of the transistor level IC design, wherein the finding includes aggregating the power consumption of the first cell and the second cell, wherein the method includes maintaining a library of previously generated sensitivity transfer functions, selecting the sensitivity transfer function from the library of previously generated sensitivity transfer functions responsively to ascertaining, with use of clustering analysis, that the cell is of a common family classification with the representative cell, and selecting the second sensitivity transfer function from the library of previously generated sensitivity transfer functions responsively to ascertaining, with use of clustering analysis, that the second cell is of a common family classification with the second representative cell, wherein the representative cell that has been subject to circuit simulation has been selected from a set of candidate cells, wherein selecting the representative cell from the set of candidate cells has included evaluating transistor dimensions of the set of candidate cells.

On completion of block 1110, CMMS 110 can proceed to criterion block 1111. At criterion block 1111, CMMS 110 can ascertain whether one or more criteria has been satisfied indicative of the current IC design having satisfactory performance according to the performed modeling. The one or more criterion can include the criterion, e.g., that the IC design according to the modeling of the IC design has satisfactory power consumption performance. By accurate and computing resource economized modeling, embodiments herein can facilitate avoidance of both under-design and over-design of integrated circuits. Under design occurs when an integrated circuit does not have the capacity to handle power consumption experienced in production. Over-design occurs when an integrated circuit has capacity that significantly exceeds capacity required to handle power consumption experienced in production. An over-designed integrated circuit results in wasted computing resources, including in terms of space consumption and hardware defining semiconductor material.

On determining at block 1112 that one or more criteria has not been satisfied, CMMS 110 at block 1111 can proceed to return block 1112. At return block 1112, CMMS 110 can prompt an administrator to enter new selection data and can return to a stage preceding block 1101 in order to obtain next selection data of an administrator user. The selection data can define an altered IC design. The promoting data can specify that the prior IC design has failed to satisfy one or more criterion.

On determining that the one or more criterion at block 1110 has been satisfied, CMMS 110 can qualify the current IC design for fabrication and proceed to block 1113 for performance of fabricating the current IC design.

After the IC design passes the sign off any checks at criterion block 1111, the design is ready to be taped out and processed for fabricating at block 1113. Fabricating at block 1113 can include providing IC design data of the IC design in an industry standard format supporting data exchange of IC design data. In one embodiment, CMMS 110 at block 1110 can format IC design data of the IC design in an industry standard format supporting data exchange of IC design data, such as Graphic Design System II (GDSII). GDSII is a binary file format representing planar geometric shapes, text labels, and other information about the layout in hierarchical form. The data can be used to reconstruct all or part of the IC design to be used in sharing layouts, transferring data between different tools, and/or creating photomasks.

At fabricating block 1110, CMMS 110 can pass an industry standard (e.g., GDSII) formatted version of the IC design for fabrication to a foundry which fabricates the IC design with use of the industry standard formatted version of the IC design and accompanying electronic design automation (EDA software), editors, viewers, and/or utilities to convert the 2D layout data into common 3D formats for fabrication using appropriate integrated circuit fabrication processes.

On completion of block 1113, CMMS 110 can proceed to return block 1114. At return block 1114 CMMS can return to a stage prior to block 1101 for receipt of next selection data of an administrator user. CMMS 110 can be iteratively performing the loop of blocks 1101-1114 for a deployment period of CMMS 110. On completion of block 1201, UE devices 120A-120Z can proceed to return block 1202. At return block 1202, UE devices 120A-120Z can return to stage preceding block 1201. UE devices 120A-120Z can be iteratively performing the loop of blocks 1201-1202 for a deployment period of system 100.

Embodiments herein recognize that cross current power consumption is the component of dynamic power consumption that occurs when both pull-up and pull-down networks are on at the same time. Embodiments herein recognize that when the input of a gate switches, there is, for a small amount of time, a direct path from V_{DD} to V_{SS} and current flows through the direct path. Embodiments herein recognize that the described current defines the cross current contributing to overall power dissipation.

Embodiments herein recognize that from FinFET technologies, cross current contribution to overall chip power has been significantly increasing (10% to 15% of dynamic power for P9 Core). Embodiments herein recognize therefore that modeling cross current power consumption accurately has become increasingly important. Embodiments herein recognize that unlike other dynamic power components (load power, device power, wire power etc.), cross current power can be heavily dependent on slew in addition to Vt, voltage, output load, process, and temperature. Embodiments herein recognize that the slew dependency of cross current power makes cross current power consumption challenging to model using logic simulation methods which are considerably faster than circuit simulation methods.

Embodiments herein provide modeling of cross current power accurately by way of a method featuring capturing slew and load sensitivities for output of a sensitivity transfer function.

Embodiments herein can provide for efficient modeling of slew-dependent switching power or cross current power of hardware. Embodiments herein can capture slew and load sensitivities using circuit simulation on a subset of circuit topologies within an IC design. Embodiments herein can model cross current as effective switching capacitance for its usage with slew-independent effective capacitance (Ceff) components. Embodiments herein can provide hierarchical segregation of output models for cross current specific evaluation and analyses, in slew and load context.

For a given PVT corner, according to one embodiment, cross current power consumption can be accurately estimated at any desired slew, load condition from a nominal value. From the nominal cross current value, its increase with slew can be modeled using slew transform and its decrease with output load is modeled using load transform. According to embodiments herein, a cross current component of power consumption can be modeled as an effective capacitance (Ceff) Modeling cross current power consumption as an effective capacitance facilitates corner independent modeling. With Ceff modeling, cross current power consumption can be computed at any given voltage, frequency, activity, slew, load conditions. Accordingly, there is no need to model/run simulations for many corners, slews and load combinations.

Embodiments herein can model a dependency of cross current power on slew as a function of cell drive strength, slew and slew sensitivity. Slew sensitivities can be derived from a representative circuit. Embodiments herein recognize that dependency of cross current power on slew can define an increasing transformation, since cross current increases with slew.

Embodiments herein can model a dependency of cross current power on output load as a function of load sensitivity and load. Embodiments herein recognize that dependency of cross current power consumption on load sensitivity can define a polynomial function with the preferred embodiment being quadratic. Embodiments herein recognize that dependency of cross current power consumption on load sensitivity can define a decreasing transform since the cross current decreases with the load.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect of a method includes performing logic simulation of a cell and determining, in dependence on the performing logic simulation of the cell, a first at least one component of power consumption of the cell, where the cell is included in a transistor level IC design selected for modeling; determining, with use of a sensitivity transfer function, a second at least one component of power consumption of the cell, where generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell; where the transistor level IC design is provided for fabrication of an integrated circuit. Other embodiments of this aspect include corresponding computer systems, apparatus, and computer programs recorded on one or more computer storage devices, each configured to perform the actions of the methods.

Implementations may include one or more of the following features. The computer implemented method where the method includes maintaining a library of previously generated sensitivity transfer functions, and selecting the sensitivity transfer function from the library of previously generated sensitivity transfer functions. The method includes maintaining a library of previously generated sensitivity transfer functions, and selecting the sensitivity transfer function from the library of previously generated sensitivity transfer functions responsively to ascertaining that the cell is of a common family classification with the representative cell. The method includes maintaining a library of previously generated sensitivity transfer functions, and selecting the sensitivity transfer function from the library of previously generated sensitivity transfer functions responsively to ascertaining, with use of clustering analysis, that the cell is of a common family classification with the representative cell. The representative cell that has been subject to circuit simulation has been selected from a set of candidate cells, where selecting the representative cell from the set of candidate cells has included evaluating size of the set of candidate cells. The representative cell that has been subject to circuit simulation has been selected from a set of candidate cells, where selecting the representative cell from the set of candidate cells has included evaluating transistor dimensions of the set of candidate cells. The method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, where generating of the second sensitivity transfer function has included subjecting a second representative cell to circuit simulation, the second representative cell having a common family classification with the second cell; ascertaining a power consumption of the second cell in dependence on the first at least one component of power consumption of the second cell and in dependence on the second at least one component of power consumption of the second cell; and finding a power consumption of the transistor level IC design, where the finding includes aggregating the power consumption of the first cell and the second cell. The method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, where generating of the second sensitivity transfer function has included subjecting a second representative cell to circuit simulation, the second representative cell having a common family classification with the second cell; ascertaining a power consumption of the second cell in dependence on the first at least one component of power consumption of the second cell and in dependence on the second at least one component of power consumption of the second cell; and finding a power consumption of the transistor level IC design, where the finding includes aggregating the power consumption of the first cell and the second cell, where the method includes maintaining a library of previously generated sensitivity transfer functions, selecting the sensitivity transfer function from the library of previously generated sensitivity transfer functions responsively to ascertaining, with use of clustering analysis, that the cell is of a common family classification with the representative cell, and selecting the second sensitivity transfer function from the library of previously generated sensitivity transfer functions responsively to ascertaining, with use of clustering analysis, that the second cell is of a common family classification with the second representative cell. The method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, where generating of the second sensitivity transfer function has included subjecting a second representative cell to circuit simulation, the second representative cell having a common family classification with the second cell; ascertaining a power consumption of the second cell in dependence on the first at least one component of power consumption of the second cell and in dependence on the second at least one component of power consumption of the second cell; and finding a power consumption of the transistor level IC design, where the finding includes aggregating the power consumption of the first cell and the second cell, where the method includes maintaining a library of previously generated sensitivity transfer functions, selecting the sensitivity transfer function from the library of previously generated sensitivity transfer functions responsively to ascertaining, with use of clustering analysis, that the cell is of a common family classification with the representative cell, and selecting the second sensitivity transfer function from the library of previously generated sensitivity transfer functions responsively to ascertaining, with use of clustering analysis, that the second cell is of a common family classification with the second representative cell, where the representative cell that has been subject to circuit simulation has been selected from a set of candidate cells, where selecting the representative cell from the set of candidate cells has included evaluating transistor dimensions of the set of candidate cells. The sensitivity transfer function models slew sensitivity of the representative cell. The sensitivity transfer function models load sensitivity of the representative cell. The sensitivity transfer function models slew sensitivity of the representative cell, where the sensitivity transfer function models load sensitivity of the representative cell. The first at least one component of power consumption of the cell includes slew independent power consumption and static power consumption. The second at least one component of power consumption of the cell includes cross current power consumption. Implementations of the described techniques may include hardware, a method or process, or computer software on a computer-accessible medium.

The system also includes a memory; at least one processor in communication with the memory; and program instructions executable by one or more processor via the memory to perform a method may include: performing logic simulation of a cell and determining, in dependence on the performing logic simulation of the cell, a first at least one component of power consumption of the cell, where the cell is included in a transistor level IC design selected for modeling; determining, with use of a sensitivity transfer function, a second at least one component of power consumption of the cell, where generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell; where the transistor level IC design is provided for fabrication of an integrated circuit. Other embodiments of this aspect include corresponding computer systems, apparatus, and computer programs recorded on one or more computer storage devices, each configured to perform the actions of the methods.

Implementations may include one or more of the following features. The system where the method includes maintaining a library of previously generated sensitivity transfer functions, and selecting the sensitivity transfer function from the library of previously generated sensitivity transfer functions. The method includes maintaining a library of previously generated sensitivity transfer functions, and selecting the sensitivity transfer function from the library of previously generated sensitivity transfer functions responsively to ascertaining that the cell is of a common family classification with the representative cell. The method includes maintaining a library of previously generated sensitivity transfer functions, and selecting the sensitivity transfer function from the library of previously generated sensitivity transfer functions responsively to ascertaining, with use of clustering analysis, that the cell is of a common family classification with the representative cell. The method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, where generating of the second sensitivity transfer function has included subjecting a second representative cell to circuit simulation, the second representative cell having a common family classification with the second cell; ascertaining a power consumption of the second cell in dependence on the first at least one component of power consumption of the second cell and in dependence on the second at least one component of power consumption of the second cell; and finding a power consumption of the transistor level IC design, where the finding includes aggregating the power consumption of the first cell and the second cell. Implementations of the described techniques may include hardware, a method or process, or computer software on a computer-accessible medium.

One general aspect includes a computer readable storage medium readable by one or more processing circuit and storing instructions for execution by one or more processor for performing a method may include: performing logic simulation of a cell and determining, in dependence on the performing logic simulation of the cell, a first at least one component of power consumption of the cell, where the cell is included in a transistor level IC design selected for modeling; determining, with use of a sensitivity transfer function, a second at least one component of power consumption of the cell, where generating of the sensitivity transfer function has included subjecting a representative cell to circuit simulation, the representative cell having a common family classification with the cell; and ascertaining a power consumption of the cell in dependence on the first at least one component of power consumption of the cell and in dependence on the second at least one component of power consumption of the cell; where the transistor level IC design is provided for fabrication of an integrated circuit. Other embodiments of this aspect include corresponding computer systems, apparatus, and computer programs recorded on one or more computer storage devices, each configured to perform the actions of the methods.

Certain embodiments herein may offer various technical computing advantages involving advantages to address problems arising in the realm of computer systems and other technologies, and to provide improvements in computer and other technology. Embodiments herein provide improved integrated circuits that are not under-designed or over-designed as a result of improved modeling. Embodiments herein can include computing resource economized methods for modeling of IC designs for production of integrated circuits. Embodiments herein can include use of logic circuit simulation and circuit simulation for performance of IC design modeling. In one aspect, circuit simulation can be performed on a representative cell for generation of sensitivity transfer function. For determination of cross current power consumption of a certain cell of an IC design, the sensitivity transfer function for the representative cell can be utilized without performing circuit simulation for the certain cell. The methodology which employs prior generated sensitivity transfer functions for determination of cross current power consumption of various cells reduces computing resource consumption relative to an alternate method in which circuit simulation is performed for the various cells. In selecting a representative cell that is representative of a family classification of cells, a system can identify the smallest cell within the family classification regarding the process. In one embodiment, a representative cell for use in subjecting to circuit analysis for generation of a sensitivity transfer function can be selected based on cell size. Embodiments herein recognize that selecting a cell in dependence on size, e.g., selecting a cell that is the smallest amongst its family members allows for faster circuit simulation. Embodiments herein recognize that sensitivity transfer functions herein can remove the need for complete library circuit simulations (which is computing resource and time consuming) while still maintaining accuracy. On detection of a cell having a common family classification with a prior registered representative cell, a sensitivity transfer function associated to the representative cell can be employed for computing resource economized determining of cross current power consumption of the detected cell. By accurate and computing resource economized modeling, embodiments herein can facilitate avoidance of both under-design and over-design of integrated circuits. Under design occurs when an integrated circuit does not have the capacity to handle power consumption experienced in production. Over-design occurs when an integrated circuit has capacity that significantly exceeds capacity required to handle power consumption experienced in production. An over-designed integrated circuit results in wasted computing resources, including in terms of space consumption and hardware defining semiconductor material. Certain embodiments can be implemented by use of a cloud platform/data center in various types including a Software-as-a-Service (SaaS), Platform-as-a-Service (PaaS), Database-as-a-Service (DBaaS), and combinations thereof based on types of subscription.

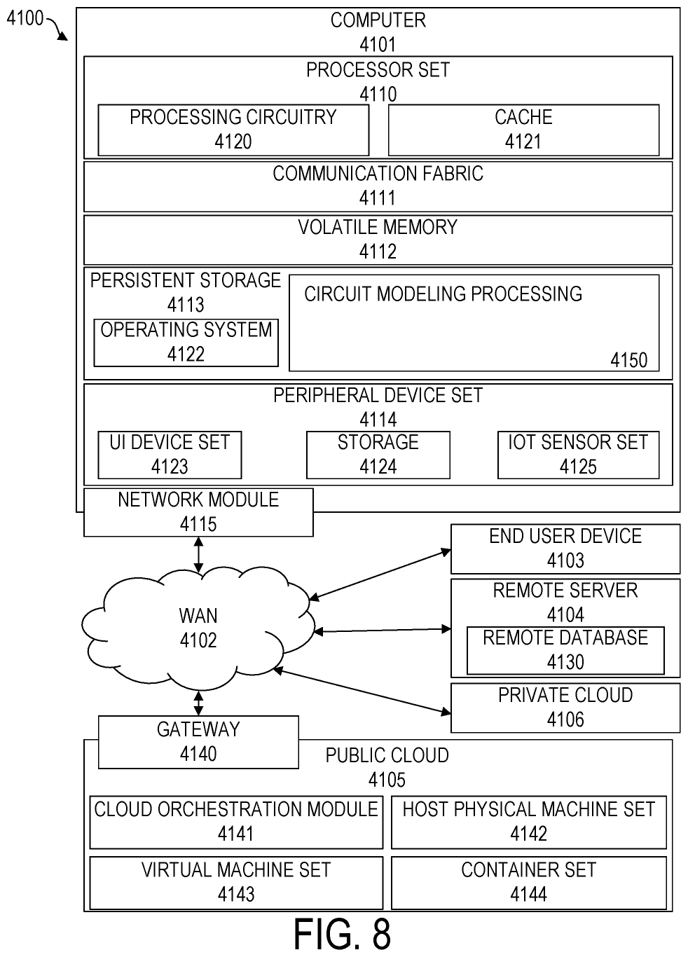

In reference to FIG. 8 there is set forth a description of a computing environment 4100 that can include one or more computer 4101. In one example, computing node 10 as set forth herein can be provided in accordance with computer 4101 as set forth in FIG. 8.

Various aspects of the present disclosure are described with reference to prophetic examples by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Hash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 8. In one aspect, a computing environment 4100 contains an example of an environment for the execution of at least some of the computer code involved in performing the inventive methods, such as code 4150 for performing circuit modeling processing described with reference to FIGS. 1-7. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method can be distributed among multiple computers and/or between multiple locations. On the other hand, in this presentation of computing environment 4100, detailed discussion is focused on a single computer, specifically computer 4101, to keep the presentation as simple as possible. Computer 4101 can be located in a cloud, even though it is not shown in a cloud in FIG. 1. On the other hand, computer 4101 is not required to be in a cloud except to any extent as can be affirmatively indicated.

Processor set 4110 includes one, or more, computer processors of any type now known or to be developed in the future. Processing circuitry 4120 can be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set can be located “off chip.” In some computing environments, processor set 4110 can be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods can be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory can be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 can be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 can be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 can be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage can be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor can be a thermometer and another sensor can be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 can be a client device, such as thin client, heavy client, mainframe computer, desktop computer and so on.

Remote server 4104 is any computer system that serves at least some data and/or functionality to computer 4101. Remote server 4104 can be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data can be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs can be stored as images and can be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
performing logic simulation of a cell and determining, in dependence on the performing logic simulation of the cell, a first at least one component of power consumption of the cell, wherein the cell is included in a transistor level IC design selected for modeling;
determining, with use of a sensitivity transfer function, a second at least one component of power consumption of the cell, wherein generating of the sensitivity transfer function has included subjecting a representative cell to circuit simulation, the representative cell having a common family classification with the cell; and
ascertaining a power consumption of the cell in dependence on the first at least one component of power consumption of the cell and in dependence on the second at least one component of power consumption of the cell;
wherein the transistor level IC design is provided for fabrication of an integrated circuit.

2. The computer implemented method of claim 1, wherein the method includes maintaining a library of previously generated sensitivity transfer functions, and selecting the sensitivity transfer function from the library of previously generated sensitivity transfer functions.

3. The computer implemented method of claim 1, wherein the method includes maintaining a library of previously generated sensitivity transfer functions, and selecting the sensitivity transfer function from the library of previously generated sensitivity transfer functions responsively to ascertaining that the cell is of a common family classification with the representative cell.

4. The computer implemented method of claim 1, wherein the method includes maintaining a library of previously generated sensitivity transfer functions, and selecting the sensitivity transfer function from the library of previously generated sensitivity transfer functions responsively to ascertaining, with use of clustering analysis, that the cell is of a common family classification with the representative cell.

5. The computer implemented method of claim 1, wherein the representative cell that has been subject to circuit simulation has been selected from a set of candidate cells, wherein selecting the representative cell from the set of candidate cells has included evaluating size of the set of candidate cells.

6. The computer implemented method of claim 1, wherein the representative cell that has been subject to circuit simulation has been selected from a set of candidate cells, wherein selecting the representative cell from the set of candidate cells has included evaluating transistor dimensions of the set of candidate cells.

7. The computer implemented method of claim 1, wherein the method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, wherein generating of the second sensitivity transfer function has included subjecting a second representative cell to circuit simulation, the second representative cell having a common family classification with the second cell; ascertaining a power consumption of the second cell in dependence on the first at least one component of power consumption of the second cell and in dependence on the second at least one component of power consumption of the second cell; and finding a power consumption of the transistor level IC design, wherein the finding includes aggregating the power consumption of the first cell and the second cell.

8. The computer implemented method of claim 1, wherein the method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, wherein generating of the second sensitivity transfer function has included subjecting a second representative cell to circuit simulation, the second representative cell having a common family classification with the second cell; ascertaining a power consumption of the second cell in dependence on the first at least one component of power consumption of the second cell and in dependence on the second at least one component of power consumption of the second cell; and finding a power consumption of the transistor level IC design, wherein the finding includes aggregating the power consumption of the first cell and the second cell, wherein the method includes maintaining a library of previously generated sensitivity transfer functions, selecting the sensitivity transfer function from the library of previously generated sensitivity transfer functions responsively to ascertaining, with use of clustering analysis, that the cell is of a common family classification with the representative cell, and selecting the second sensitivity transfer function from the library of previously generated sensitivity transfer functions responsively to ascertaining, with use of clustering analysis, that the second cell is of a common family classification with the second representative cell.

9. The computer implemented method of claim 1, wherein the method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, wherein generating of the second sensitivity transfer function has included subjecting a second representative cell to circuit simulation, the second representative cell having a common family classification with the second cell; ascertaining a power consumption of the second cell in dependence on the first at least one component of power consumption of the second cell and in dependence on the second at least one component of power consumption of the second cell; and finding a power consumption of the transistor level IC design, wherein the finding includes aggregating the power consumption of the first cell and the second cell, wherein the method includes maintaining a library of previously generated sensitivity transfer functions, selecting the sensitivity transfer function from the library of previously generated sensitivity transfer functions responsively to ascertaining, with use of clustering analysis, that the cell is of a common family classification with the representative cell, and selecting the second sensitivity transfer function from the library of previously generated sensitivity transfer functions responsively to ascertaining, with use of clustering analysis, that the second cell is of a common family classification with the second representative cell, wherein the representative cell that has been subject to circuit simulation has been selected from a set of candidate cells, wherein selecting the representative cell from the set of candidate cells has included evaluating transistor dimensions of the set of candidate cells.

10. The computer implemented method of claim 1, wherein the sensitivity transfer function models slew sensitivity of the representative cell.

11. The computer implemented method of claim 1, wherein the sensitivity transfer function models load sensitivity of the representative cell.

12. The computer implemented method of claim 1, wherein the sensitivity transfer function models slew sensitivity of the representative cell, wherein the sensitivity transfer function models load sensitivity of the representative cell.

13. The computer implemented method of claim 1, wherein the first at least one component of power consumption of the cell includes slew independent power consumption and static power consumption.

14. The computer implemented method of claim 1, wherein the second at least one component of power consumption of the cell includes cross current power consumption.

15. A system comprising:
a memory;
at least one processor in communication with the memory; and
program instructions executable by one or more processor via the memory to perform a method comprising:
performing logic simulation of a cell and determining, in dependence on the performing logic simulation of the cell, a first at least one component of power consumption of the cell, wherein the cell is included in a transistor level IC design selected for modeling;
determining, with use of a sensitivity transfer function, a second at least one component of power consumption of the cell, wherein generating of the sensitivity transfer function has included subjecting a representative cell to circuit simulation, the representative cell having a common family classification with the cell; and
ascertaining a power consumption of the cell in dependence on the first at least one component of power consumption of the cell and in dependence on the second at least one component of power consumption of the cell;
wherein the transistor level IC design is provided for fabrication of an integrated circuit.

16. The system of claim 15, wherein the method includes maintaining a library of previously generated sensitivity transfer functions, and selecting the sensitivity transfer function from the library of previously generated sensitivity transfer functions.

17. The system of claim 15, wherein the method includes maintaining a library of previously generated sensitivity transfer functions, and selecting the sensitivity transfer function from the library of previously generated sensitivity transfer functions responsively to ascertaining that the cell is of a common family classification with the representative cell.

18. The system of claim 15, wherein the method includes maintaining a library of previously generated sensitivity transfer functions, and selecting the sensitivity transfer function from the library of previously generated sensitivity transfer functions responsively to ascertaining, with use of clustering analysis, that the cell is of a common family classification with the representative cell.

19. The system of claim 15, wherein the method includes performing logic simulation of a second cell of the IC design and determining, in dependence on the performing logic simulation of the second cell, a first at least one component of power consumption of the second cell; determining, with use of a second sensitivity transfer function, a second at least one component of power consumption of the second cell, wherein generating of the second sensitivity transfer function has included subjecting a second representative cell to circuit simulation, the second representative cell having a common family classification with the second cell; ascertaining a power consumption of the second cell in dependence on the first at least one component of power consumption of the second cell and in dependence on the second at least one component of power consumption of the second cell; and finding a power consumption of the transistor level IC design, wherein the finding includes aggregating the power consumption of the first cell and the second cell.

20. A computer program product comprising:
a computer readable storage medium readable by one or more processing circuit and storing instructions for execution by one or more processor for performing a method comprising:
performing logic simulation of a cell and determining, in dependence on the performing logic simulation of the cell, a first at least one component of power consumption of the cell, wherein the cell is included in a transistor level IC design selected for modeling;
determining, with use of a sensitivity transfer function, a second at least one component of power consumption of the cell, wherein generating of the sensitivity transfer function has included subjecting a representative cell to circuit simulation, the representative cell having a common family classification with the cell; and
ascertaining a power consumption of the cell in dependence on the first at least one component of power consumption of the cell and in dependence on the second at least one component of power consumption of the cell;
wherein the transistor level IC design is provided for fabrication of an integrated circuit.
